(19) United States
(12) Patent Application Publication
(10) Pub. No.: US 2007/0042749 A1
(43) Pub. Date: Feb. 22, 2007

(54) Portable loss prevention system

(76) Inventor: Mourad Ben Ayed, Revere, MA (US)

Correspondence Address: MOURAD BEN AYED, 315 Charger St, #67, Revere, MA, 02151, US

(21) Appl. No.: 11/327,505

(22) Filed: Jan. 9, 2006

Related U.S. Application Data
(63) Continuation-in-part of application No. 11/204,483, filed on Aug. 17, 2005.

(51) Int. Cl. H04M 11/04; H04Q 7/20

(52) U.S. Cl. 455/404.2; 455/421

(57) ABSTRACT

A portable proximity detection system containing a standards based short wireless transceiver, a controller and an alarm system monitors the presence of a portable electronic device equipped with a compatible transceiver within range and alarms when that device leaves its range.

### FIELD OF THE INVENTION

This invention is directed generally to loss prevention systems, proximity detection systems, and more specifically to a portable device that monitors the presence of a wireless communication device and that issues an alarm when said device is not within proximity.

### BACKGROUND OF THE INVENTION

Portable electronic devices such as cellular telephones, personal digital assistants (PDAs), wireless email devices, instant messaging devices, pagers, portable compact disk (CD) players, and portable MP3 players, and others are often forgotten, lost or stolen.

Existing wireless device loss detection approaches focus primarily on remotely accessing the lost device. This allows prohibiting the device from placing phone calls. It also allows hiding the device owner' information or erase sensitive data. This strategy aims to increase the user's chances of recovering the device and to protect data stored in the device. This method does not allow users to quickly recover their lost devices.

Other methods for tracking and locating a lost cell phone consist in network triangulation and GPS interrogation. This method does not allow users to instantaneously recover their lost devices.

U.S. Pat. No. 6,836,212 by Sawinski discloses a method and apparatus for reducing the likelihood of loosing a portable electronic device by monitoring inadvertent removal of a portable electronic device from its retaining device. This method does not protect users from loosing their devices after removing them from retaining devices.

There is a need for a more convenient and reliable method and apparatus for alarming users upon detecting their wireless communication devices are not within range.

### SUMMARY OF INVENTION

A unitary remotely configurable portable electronic loss prevention system comprising a transceiver means for discovering compatible devices within range, an activation system such as a timer or a motion detection system, a memory for storing the address of a monitored portable electronic device, an alarm, and a processor for detecting the presence of the monitored device within range and for activating the alarm if the monitored device is not detected. If the monitored device is detected, the processor also turns off the transceiver to conserve battery.

A method for monitoring proximity to a portable electronic device using a remotely configurable unitary portable detection system comprising automatically turning on a transceiver, automatically trying to detect a monitored device within range, if the device is not found, an alarm is activated, if a match is found, the transceiver is turned off.

### BRIEF DESCRIPTION OF THE DRAWINGS

The present invention with be more clearly understood after reference to the following detailed specifications read in conjunction with the drawings wherein:

FIG. 1 is a schematic of a portable loss prevention system

FIG. 2 is a block diagram of portable loss prevention system

FIG. 3 is a flowchart illustrating the operation of a loss prevention system

FIG. 3b is a flowchart illustrating an alternative operation of a loss prevention system

FIG. 4 is a flowchart illustrating initiating the loss prevention system

FIG. 5 is a flowchart illustrating configuring the loss prevention system

FIG. 6 is a flowchart illustrating the operation of a portable electronic device

Similar reference numerals are used in different figures to denote similar components.

### DETAILED DESCRIPTION OF THE PREFERRED EMBODIMENTS

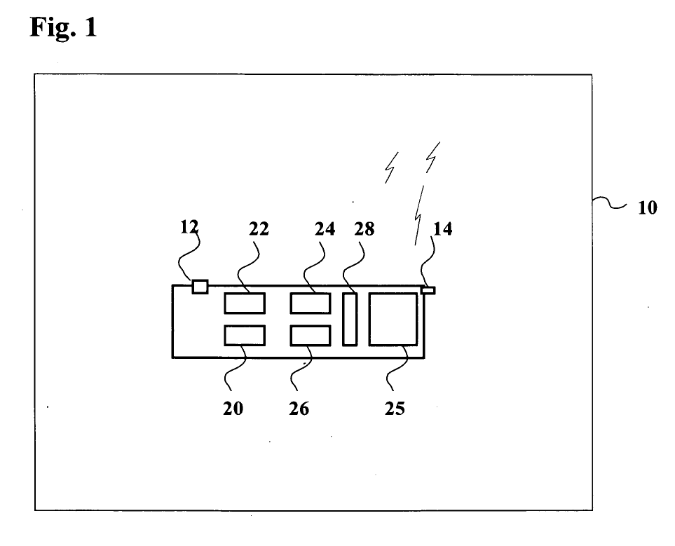

FIG. 1 is schematic of a portable loss prevention system 10 comprising a processor 20 interconnected with switches 12, control system 22, memory 28, transceiver 26, battery 24, alarm center 25 and antenna 14. An attachment system, such as a hook, pin, clip, badge, key chain, Velcro, ring, fastening mechanism or stick surface may be attached to the loss prevention system.

Switches 12 can be any type of button, switch, remote sensor, touch sensor, contact sensor or activation system. Switches 12 are used to initiate or to reset the loss prevention system. Switches 12 may be used to turn on/off the loss prevention system or to shut off alarm center 25.

Control system 22 can be a simple timer that triggers loss prevention system 10 to wake up on a periodic basis, and to check for the presence of the monitored device within range.

The timer period can be set either by activating a switch 12, or by remotely configuring the loss prevention system 10 using the monitored device. For example, the user can change the timer period to 1, 2 or 5 minutes, or any other period using the input interface of the monitored device. The user can choose the time of the day the alarm operates so that the alarm does not start at inconvenient times. The user can also choose the alarm types and melody tones, etc.

Control system 22 can be a motion sensor device capable of detecting a change from idle state to moving state, MEMS gyroscopes, MEMS accelerometers, tilt sensors, vibration sensor, or a combination of the above. MEMS are micro-electromechanical systems or microscopic machines with electrical and mechanical parts on a silicon chip. Gyroscopes can be any kind of angular rate sensors such as those manufactured by Analog Devices, which generate output signals that are indicative of angular rates. The output signals may be converted to data sequences using electronic components such as resistors and capacitors. Accelerometers can be any kind of acceleration sensors such as those manufactured by Analog Devices, which generate output signals that are indicative of the acceleration. The output signals are converted to data sequences.

Transceiver 26 is any type of transceiver or a combination of transmitter and receiver. In a preferred embodiment, transceiver 26 is a short range low power transceiver that conforms to a standard specification. In a preferred embodiment, Transceiver 26 conforms to Bluetooth specifications (Bluetooth may also be spelled BlueTooth, with both terms considered equivalent herein). Transceiver 26 can discover other compatible transceivers within range. Transceiver 26 can establish a temporary two-way connection or a piconet network with other devices equipped with compatible transceivers.

In another embodiment, a short range transceiver 26 can be a WIFI, WiMax, Zigbee transceiver, any kind of transceiver capable of communicating with a Bluetooth transceiver within a short range, or any widely available standard based short range transceiver technology. A short range is defined as a distance less than 100 meters. A short range transceiver is a peer to peer communication technology. The transceiver is capable of communicating directly with another transceiver without going through a third system. Transceiver 26 is usually identified by an address. An address is a Bluetooth address, a server name or MAC address, an ID or any kind of identifier.

Bluetooth uses radio chips in electronic devices to enable connectivity over the 2.4 GHz radio frequency (RF) band. The Bluetooth specification (a de facto standard containing information required to ensure that devices supporting Bluetooth can communicate with each other worldwide) defines two transmission ranges for personal area networking. The range is between 10 m and 100 m without a line of sight requirement. The radio link is capable of voice and data transmission up to a maximum capacity of 720 kbps per channel.

A Bluetooth network is completely self organising, and ad hoc personal area networks (PANs) can be established wherever two or more Bluetooth devices are sufficiently close to establish radio contact. Equipment capable of Bluetooth connectivity is able to self-organise by automatically searching within range for other Bluetooth-enabled devices. Upon establishing a contact, information is exchanged which determines if the connection should be completed or not.

During this first encounter, the Bluetooth devices connect via a process of authorisation and authentication.

Here is how Bluetooth devices connect to each other: Unlike the wired technology Bluetooth is designed to replace, a Bluetooth device does not have to be aware of the devices and capabilities they are attaching to. There is a built in mechanism to inquire for devices (in other terms, discover devices within range), connect to them and once connected discover the services they possess in their database. In its simplest form the devices needing to connect proceed as follows:

1) The master enters inquiry mode and sends out an inquiry to discover devices available to connect to.

2) Potential slaves make themselves discoverable by entering inquiry scan mode and listen for an inquiry from a master.

3) On receiving an inquiry, the slave responds to the master with a Frequency Hop Synchronization packet (FHS). The FHS contains information that is needed to create a connection to the device; this information includes its Bluetooth address and class of device.

4) The master collects the FHS information from each device discovered.

5) To connect to one of these devices the master goes into page mode and will page the device using the corresponding Bluetooth address and wait for a response within a period of time usually less than a few minutes. The slave being paged by a master will need to be in page scan mode to be able to connect to a master.

In the case of Bluetooth, there are two standards.

1—Class 2: a class 2 Bluetooth transceiver can discover, pair and communication with any Bluetooth transceiver within a radius of 10 meters seamlessly.

2—Class 1: A class 1 Bluetooth transceiver can discover, pair and communication with any Bluetooth transceiver within a radius of 100 meters.

A non-standard based Bluetooth transceiver can have any desirable range. The range can also be designed to be user adjustable through a range control system. The range of a class 1 or class 2 Bluetooth devices or any transceiver can be modified by changing the RF properties, power, or the antenna properties, shape, surface, angle . . . These changes can be monitored using a switch, a knob, a software interface, or any other interface. In a preferred embodiment, the range of transceiver 26 can be changed between the values of 5 and 10 meters. The range can also be given a value between 1 and 100 meters, such as 5, 10, 20, 30, 50, 100. The range can be boosted to 200 or 300 meters for some applications.

In the case transceiver 26 is a Wifi, WiMax or a Zigbee transceiver; the transceiver range would be reduced to a small range usually 10 meters or a value less than 30 meters. In this system, a Wifi/WiMax/Zigbee equipped cell phone/PDA/portable computer would act as a server. System 10 would monitor and detect the presence of that specific server within range. If that specific server is not detected, alarm 25 is triggered. The transceiver range can also be user adjustable through a range control system.

Battery 24 provides power to some of the components of loss prevention system 10. It will be understood that battery 24 may be a fuel cell, nickel-cadmium, lithium, alkaline or nickel-hydride battery or any other portable source of electric power. Battery 24 can also be replaced with photovoltaic cells, a rechargeable batteries, batteries rechargeable from a distance, (such as by induction).

When loss prevention system 10 is not in operation it remains in a dormant state (“sleep-mode”) to conserve the energy of battery 24.

Alarm center 25 is an alarm audible from a distance larger than 6 feet. A regular alarm is between 65 and 120 decibels at 10 feet. Noise levels above 85 decibels will harm hearing over time. Noise levels above 140 decibels can cause damage to hearing after just one exposure. In a preferred embodiment, alarm center 25 has more than 60 decibels at 10 feet or exceeds ambient sound level by 5 decibels minimum. Alarm center 25 can be any type of audio, video, tactile or mechanical user interface means capable of conveying information to the user. Audio means can be any audio device such as a speaker, a buzzer, a Piezo buzzer, omni directional speaker, directional speaker, an ultrasound or any other audio device. Visual means can be an LED, or any visual information display device. Tactile means can be any tactile sensor such as a vibrator, or a heat-generating device.

Antenna 14 can be any type of antenna including patch antenna and dipole antennas.

Processor 20 reads events from control system 22 and automatically activates transceiver 26. Processor 20 also reads events from switches 12 and performs initialization, reset, stop tasks and others. Processor 20 stores the identity of a monitored device in memory 28. It performs detection tasks and triggers alarm center 25 if the monitored device is not found within range. Processor 20 performs tasks to minimize consumption of battery power from batteries 24. It can also control the range of antenna 14.

Portable loss prevention system 10 can be incorporated in human, animals or objects such as portable computers. It can be inserted in a capsule under the skin. It can also be carried as a keychain or attached to people, animals or objects through a hook, Velcro, pin, badge, clip, ring, fastening mechanism or any other attachment mechanism.

Portable loss prevention system 10 can also be encased in a waterproof packaging and attached to clothes. The packaging can also be shock or impact resistant. System 10 can be incorporated in any other plastic or electronic device or object, including a cell phone, PDA, a wireless email device, an instant messaging device or pager, a portable computer, an MP3 player, a portable music player, a portable radio device, or any portable electronic device. It can also be sawn in clothes.

System 10 is a small system usually less than 10 cm×10 cm×5 cm and less than 200 g in weight. It has a few buttons, and may or may not have a display. In a preferred embodiment, system 10 has a size smaller than 5 cm×3 cm×1.5 cm. It is less than 50 g, has less than 4 buttons or switches, and no display.

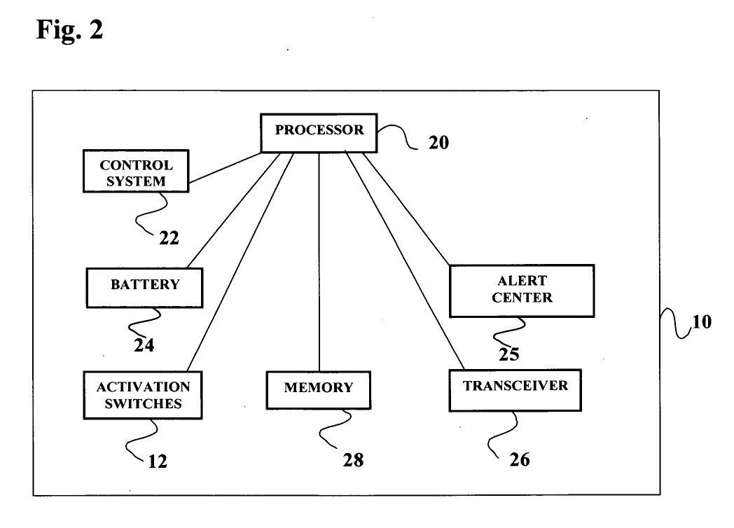

Referring now to FIG. 2, in one embodiment, portable loss prevention system 10 comprises a processor 20 interconnected with switches 12, control system 22, memory 28, transceiver 26, battery 24, and alarm center 25.

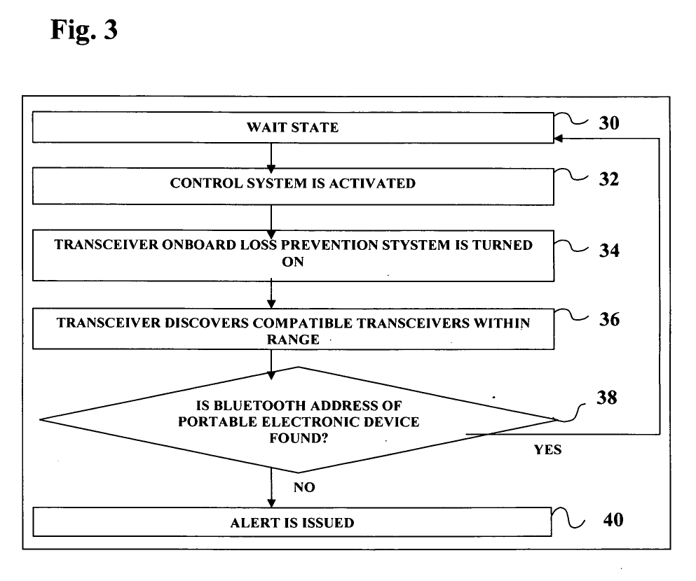

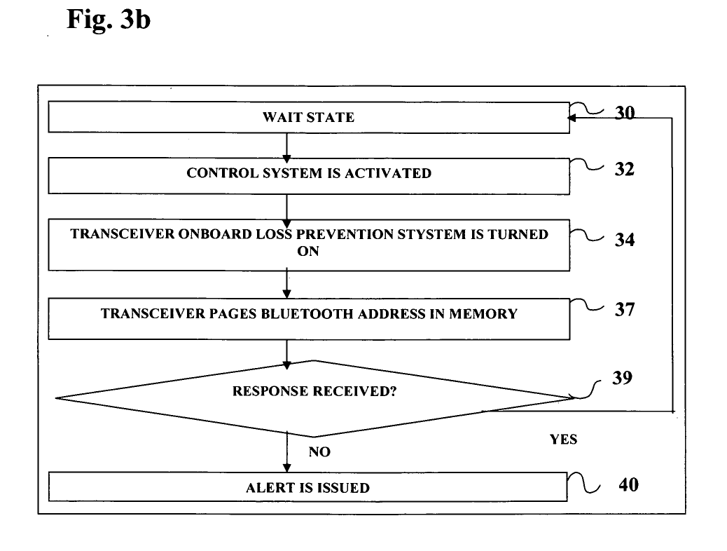

Turning now to FIG. 3, the flowchart illustrates the steps involved in detecting that a portable electronic device is outside a range.

Portable electronic device is a cell phone, a PDA, a wireless email device, an instant messaging device or pager, a portable computer, an MP3 player, a portable music player, a portable radio, or any portable electronic device.

In step 30 the loss prevention system is in sleep mode. In step 32, control system 22 activates the system. Control system 22 can be a motion detector or a timer. In step 34 transceiver 26 is turned on and in step 36, it discovers compatible transceivers within range. A compatible transceiver is a transceiver with similar protocol. In the case of Bluetooth, a compatible transceiver is a Bluetooth transceiver. In the case of WIFI/Zigbee/WiMax, it is a WIFI/Zigbee/WiMax transceiver respectively.

In step 36, the transceiver onboard the loss prevention system enters inquiry mode and sends out an inquiry to discover devices available to connect to. Monitored devices are set as discoverable. They make themselves discoverable by entering inquiry scan mode and listening for an inquiry from a master. On receiving an inquiry, the monitored device responds to the loss prevention system and sends its address.

In step 38, Processor 20 reads the address of a portable electronic device being monitored from memory and compares it to discovered transceiver addresses. If a match is found, the transceiver is turned off, and goes to a sleep mode in step 30 in order to conserve battery power. In the case of Bluetooth, transceiver 26 may be turned off before the Bluetooth authorization and authentication steps are completed or without establishing a Bluetooth connection. If the address of the portable monitored electronic device is not found, processor 20 issues an alarm to the user in step 40. Processor 20 can start a buzzer, a vibrator, or a sound system. Processor 20 can also activate LEDs. An example of an audible warning message could loudly state “Your phone is no longer in authorized area” or “This child or dog is separated from his family, please call . . . ”

Turning now to FIG. 3b, the flowchart illustrates the steps involved in detecting that a portable electronic device is outside a range.

In step 30 the loss prevention system is in sleep mode. In step 32, control system 22 detects an event and activates the system. The event can be a motion in case of a motion detector, or a timer event in case of a timer. In step 34, transceiver 26 is turned on and in step 37, it obtains the address of the monitored portable electronic device from memory and pages it.

In step 39, Processor 20 checks if a paging response is received after a period of time, usually less than a few minutes. If a response is received, transceiver 26 is turned off, and goes to a sleep mode in step 30 in order to conserve battery power. period of time, system 10 stops its search, and waits for a pairing request from a phone or PDA device.

In this preferred embodiment, on initialization or reset, system 10 makes itself discoverable, and automatically tries to discover and detect a similar device within range. If it detects a similar device, it initiates a pairing request. If it receives a pairing request, it responds to the pairing request.
1) If system 10 is the initiator of the pairing request, system 10 will make itself discoverable by the partner device.
2) If system 10 is the receiver of a pairing request, system 10 will periodically detect the presence of the partner device within range.
3) In the case system 10 is the initiator of the pairing request, system 10 can in parallel periodically detect the presence of the partner device within range.

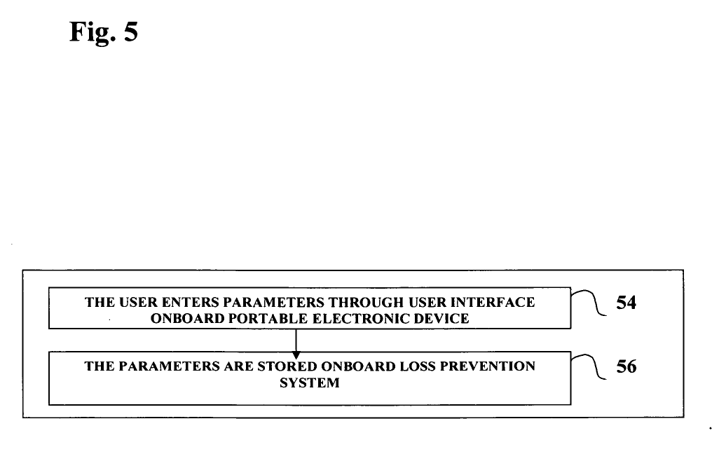

Turning now to FIG. 5, the flowchart illustrates the configuration of the loss prevention system 10 using a portable electronic device.

In step 54, the user views and enters configuration parameters through a user interface onboard the portable electronic device. Configuration parameters may include operation hours, operation days, buzzer type, buzzer volume, buzzer duration, alarm type. The configuration parameters are stored onboard the loss prevention system in step 56 and can be used to change the properties or to program said loss prevention system.

The user may also record a voice message that will be broadcasted in the event of an alarm. For example, a message containing “Please call 123

If a paging response is not received, processor 20 issues an alarm to the user in step 40.

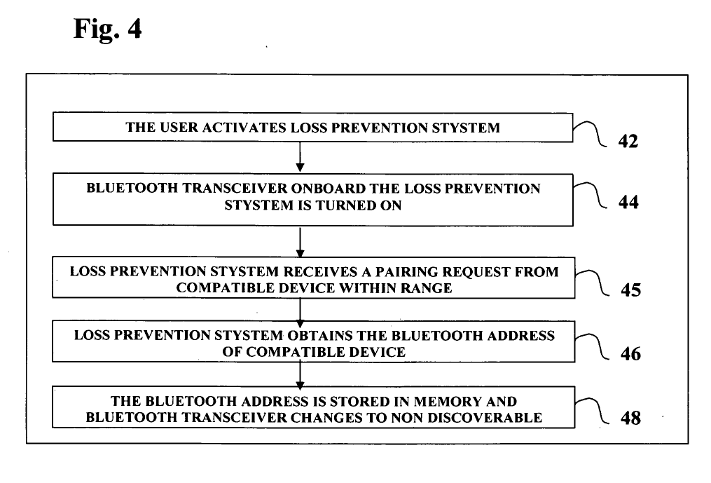

Turning now to FIG. 4, the flowchart illustrates the steps involved in initializing the loss prevention system.

In step 42, the user activates loss prevention system 10. The loss prevention system is either activated for the first time, or has been reset. Transceiver 26 is turned on in step 44. It is set as discoverable, and it waits for requests from other compatible devices. In step 46, it receives a pairing request from a compatible device within range, and after authentication, it obtains the address of the compatible device. An LED, a buzzer or an audio device may be activated to inform the user of the success/failure of the operation. The user may be prompted to enter a pass key that will be authenticated. The pass key can be entered using the monitored device' keyboard, for example, in the case of a cell phone, the password is entered using the cell phone keyboard. In step 48, said address is stored in memory. After this step, the loss prevention system 10 changes to non discoverable.

In another embodiment, at initialization phase, system 10 searches for other similar devices within range, for a period of time. A similar device can have a specific class of device or another known feature. If that device is found, system 10 pairs with that device, and in a way, the two devices become proximity detection devices and would alarm if the distance between them exceeds a limit. If a similar device is not found within the 456 7890” or any other message would be broadcasted with the alarm. The voice message will be stored onboard the loss prevention system in step 56. The voice message can be entered through the portable electronic device or can be entered through the loss prevention system.

At initialization stage, the loss prevention system can transfer a program to the portable electronic device. The program can install a user interface or some functionality on the portable electronic device. For example, the program can allow the portable electronic device to store the address of the loss prevention system and to monitor the presence of the loss prevention system within range. This will also allow the portable electronic device to issue an alarm when the loss prevention system leaves range.

The user interface is a program that can be installed onboard the portable electronic device. It can be transferred from the monitoring device, from a CD, or from other medium such as Internet.

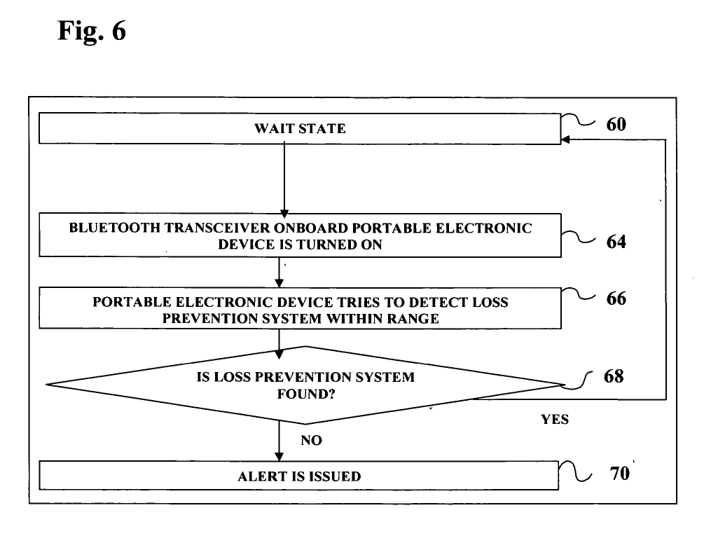

Turning now to FIG. 6, the flowchart illustrates the steps involved in detecting that a loss prevention system is outside the range of portable electronic device. This flowchart can be complementary to FIG. 3, and can be executed in parallel with the flowchart of FIG. 3. This method allows a double monitoring whereby the loss prevention system monitors the portable electronic device, and in parallel, the portable electronic device monitors the loss prevention system. This way, if the distance between the two devices exceeds a tolerable distance, both devices can issue alarms.

This method also allows the loss prevention system 10 to interact with another similar loss prevention system. This allows two people to carry a loss prevention system each. If the range between the two people exceeds a certain distance, an alarm starts on both devices.

In step 60 the portable electronic device is in sleep mode for a predetermined period of time. In step 64, after the period of time is expired, a transceiver onboard the portable electronic device is turned on and in step 66, it discovers compatible transceivers within range.

In step 68, a processor onboard the portable electronic device reads the address of loss prevention system being monitored from memory and compares it to discovered transceiver addresses. If the address of the loss prevention system being monitored is found in the discovered transceiver addresses, the transceiver is turned off, and the system goes to a sleep mode in step 60. In a preferred embodiment, the Bluetooth connection may be turned off before the Bluetooth authorization and authentication steps are completed.

If the address of the loss prevention system is not found, an alarm is issued in step 60. The alarm can be in the form of a buzzer, a vibrator, or a sound. LEDs can also be activated. An example of an audible warning message could loudly state “Your device is no longer in authorized area”.

Numerous other modifications, variations, and adaptations may be made to the particular embodiment of the invention described above without departing from the scope of the invention, which is defined in the claims. Hence, while exemplary embodiments of the present invention have been set forth above, it is to be understood that the pioneer inventions disclosed herein may be constructed or used otherwise than as specifically described.

What is claimed is:

1—A unitary mobile proximity detection device comprising:
an alarm system with a sound level greater than 60 decibels, a control system,
a short range wireless transceiver selected from the set comprised of Bluetooth transceiver, WIFI transceiver, WiMax transceiver, Zigbee transceiver,
a memory for storing the address of a monitored mobile device selected from the set comprised of a wireless communication device, a cell phone, a portable MP3 player, a portable video player, a PDA, whereby on activation of said control system,
a processor automatically:
turns said transceiver on,
tries to detect said monitored mobile device within range,
if detection is not successful,
said processor activates said alarm system.

2—The device of claim 1 whereby said short range is selected from the set comprised of 5, 10, 20, 30, 50 and 100 meters.

3—The device of claim 1 whereby said control system is a timer.

4—The device of claim 1 whereby said control system is selected from the set comprised of motion detector, switches, tilt sensors, vibration sensors, accelerometers, gyroscopes.

5—The device of claim 1 comprising an attachment system selected from the set comprised of hook, pin, clip, key chain, Velcro, ring, fastening mechanism, stick surface.

6—The device of claim 1 comprising
a range control system for modifying the range of said short range transceiver.

7—A method for monitoring proximity to a first mobile device equipped with a short range transceiver using a second mobile device equipped with a short range transceiver, said short range transceiver is selected from the set comprised of Bluetooth transceiver, WIFI transceiver, Zigbee transceiver, comprising:
on accepting a pairing request from said first device,
storing the address of said first device onboard said second device.
automatically:
activating said transceiver onboard said second device and trying to detect said first device within range,
if detection is not successful, issuing an alarm greater than 60 decibels.

8—The method of claim 7 comprising:
Periodically
activating said transceiver onboard said second device and trying to detect said first device within range,
if detection is not successful,
issuing an alarm greater than 60 decibels.

9—The method of claim 7 whereby on detecting motion, automatically:
turning on a transceiver,
automatically trying to detect said first device within range,
if detection is not successful,
issuing an alarm greater than 60 decibels.

10—The method of claim 7 whereby trying to detect said first device comprises:
sending a page to said first mobile device and waiting for a response within a period of time,
if a response is received, detection is successful, otherwise, detection is not successful.

11—The method of claim 7 whereby trying to detect said first device comprises:
discovering compatible devices within range,
comparing the addresses of discovered devices with said address of said first device from memory,
if a match is not found, detection is successful, otherwise, detection is not successful.

12—The method of claim 7 wherein
if detection is successful,
turning off said transceiver onboard said second device.

13—The method of claim 7 whereby said accepting a pairing request comprises:
entering a pass key,
validating said pass key.

14—The method of claim 7 comprising attaching said second device to an entity selected from the set comprised of person, animal, object.

15—The method of claim 7 comprising incorporating said second device in objects.

16—The method of claim 7 comprising inserting said second device under the skin.

17—The method of claim 7 comprising
recording a user message,
on activation of said alarm,
playing said user message.

18—The method of claim 7 whereby
said second device is remotely configurable using said first device.

19—The method of claim 7 comprising
sending a program to said first device,
executing said program onboard said first device.

20—The method of claim 7 comprising
running an application onboard said first device,
storing the address of said second device onboard said first device,
periodically,
trying to detect said second device within range,
if detection is not successful, alarming.

21—A method for initializing a Bluetooth proximity monitoring device comprising:
on event selected from the set comprised of initialization and reset,
automatically,
periodically,
detecting similar devices within range,
scanning for pairing requests from other devices,
until a pairing is completed.
